(19) United States
(12) Patent Application Publication
(10) Pub. No.: US 2009/0004754 A1
(43) Pub. Date: Jan. 1, 2009

(54) MULTI-WELL RESERVOIR PLATE AND METHODS OF USING SAME

(76) Inventor: Kevin R. Oldenburg, Spokane Valley, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/146,869

(22) Filed: Jun. 26, 2008

Related U.S. Application Data
(60) Provisional application No. 60/946,331, filed on Jun. 26, 2007.

(51) Int. Cl. G01N 1/28; B01L 3/00

(52) U.S. Cl. 436/174; 422/102

(57) ABSTRACT

The present disclosure generally relates to a multi-well reservoir plate and methods of using the same. The multi-well reservoir plate includes a frame portion coupled to a plate portion, where a number of receptacles are formed in the plate portion. The receptacles or wells are sized to receive and support a substance without permitting the substance to leak or discharge from a passage formed in a lower portion of the well and in fluid communication with an upper portion of the well where the substances is supported. In one embodiment, the wells are at least partially filled with a substance, the substance is supported the in the wells for an amount of time, and then the substance is discharged from the wells by applying a force to the substance. By way of example, the force may be a pressure applied to an upper surface of the substance, a pressure (e.g., vacuum) applied to a lower surface of the substance, and/or an inertial force generated by an acceleration of the substance.

### CROSS-REFERENCE TO RELATED APPLICATION

This application claims the benefit under 35 U.S.C. § 119(e) of U.S. Provisional Patent Application No. 60/946,331 filed Jun. 26, 2007; which application is incorporated herein by reference in its entirety.

### BACKGROUND OF THE INVENTION

1. Field of the Invention

The disclosure generally relates to a multi-well reservoir plate for handling and/or transferring a substance, as well as methods of using the same.

2. Description of the Related Art

High throughput assays involve replicating multiple reactions, very often in standard formats such as microtiter plates. Traditionally, such procedures may involve multiple pipetting steps for adding or transferring reagents and/or biological or chemical samples, as well as additional pipetting for any necessary washing steps. Unfortunately, multiple pipetting steps may lead to inaccurate reaction and/or sample volumes, contamination of reagents and/or samples as well as loss of reagents and/or samples. Errors such as these are accentuated when the handler is working with very small reaction and/or sample volumes.

Thus, it would be desirable to have an alternative device and methods for handling a sample and/or a reagent in a microtiter plate format.

### BRIEF SUMMARY OF THE INVENTION

In one aspect, a carrier includes a frame; and a plate coupled to the frame, the plate having a plurality of receptacles formed in the plate, at least one receptacle having an upper portion having a first wall forming a first volume, a tapered portion having a tapered wall forming a second volume, and a lower portion having a lower wall forming a passage, the tapered portion is disposed between the upper portion and the lower portion, the upper portion includes a receiving opening with a first perimeter, the lower portion includes a discharge opening at one end of the passage, wherein the passage is in fluid communication with the first volume of the upper portion, the discharge opening includes a with a second perimeter that is smaller than the receiving opening of the upper portion by an extent that a substance that is received in one or both of the first and second volumes remains therein until acted upon by an amount of applied force.

In another aspect, a method of using a multi-well reservoir plate includes adding at least one substance to at least one well of the reservoir plate; supporting the at least one substance in an upper volume portion of the at least one well for an amount of time, wherein a first portion of the at least one substance is supported by a tapered wall of the well and another portion of the at least one substance spans an opening of a passage formed in and extending through a lower portion of the well; and discharging at least some of the at least one substance from the upper volume portion of the well out of the passage in the lower portion of the well by applying an amount of force to the at least one substance.

### BRIEF DESCRIPTION OF THE SEVERAL VIEWS OF DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements and have been solely selected for ease of recognition in the drawings.

FIG. 1 is top plan view of a multi-well reservoir plate having a number of wells for receiving substances, according to one illustrated embodiment.

FIG. 2 is a side elevational view of the multi-well reservoir plate of FIG. 1.

FIG. 3 is bottom plan view of the multi-well reservoir plate of FIG. 1.

FIG. 4 is a cross-sectional view of the multi-well reservoir plate of FIG. 1 taken along line 4-4 of FIG. 1.

FIG. 5A is a detailed view of one of the wells of the multi-well reservoir plate of FIG. 4.

FIG. 5B is a detailed view of three of the wells of the multi-well reservoir plate of FIG. 4.

FIG. 6 is a more detailed view of the one well of FIG. 5A.

FIG. 7 is a schematic view of a substance located in one of the wells of the multi-well reservoir plate of FIG. 4, where a portion of the substance spans an opening, according to one illustrated embodiment.

FIG. 8A is a schematic view of an external force acting on a surface of the substance within one of the wells of the of the multi-well reservoir plate of FIG. 4, according to one illustrated embodiment.

FIG. 8B is a schematic view of the surface tension reaction forces that balance the weight of the substance and thus maintain the substance from being discharged from one of the wells of the multi-well reservoir plate of FIG. 4, according to one illustrated embodiment.

FIG. 9 is a flowchart showing a method of using a multi-well reservoir plate to hold and then transfer one or more substances located therein, according to one illustrated embodiment.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures and methods associated with microtiter, micro, and/or multi-welled plates and methods of manufacturing and/or using the same may not be shown or described in detail to avoid unnecessarily obscuring descriptions of the embodiments of the invention.

Unless the context requires otherwise, throughout the specification and claims which follow the word “comprise” and variations thereof, such as “comprises” and “comprising,” are to be construed in an open, inclusive sense, that is, as “including, but not limited to.”

The headings, if any, provided herein are for convenience only and do not interpret the scope or meaning of the claimed invention.

The present disclosure generally relates to a reservoir plate having a number of receptacles (hereinafter referred to as wells), where such a reservoir plate is commonly referred to as a multi-well reservoir plate. The wells generally operate to hold, store, receive, support, or otherwise retain an amount of substance for least some amount of time. The substance in the wells of the multi-well reservoir plate may be a solid, liquid (organic or otherwise), gel, paste, emulsion, viscous liquid, vapor or other reagent and/or sample. In one embodiment, the wells have a funnel-type configuration with an upper orifice or opening to receive the substance and a lower, smaller orifice or opening to eject, release, or otherwise discharge the substance.

The multi-well reservoir plate may advantageously be employed to handle a variety of biological and/or chemical assays, reagents, and/or biological or chemical samples. By way of example, the multi-well reservoir plate may be used to handle high throughput screening assays while bypassing the at least one pipetting step. The pipetting step is necessary with the wells of conventional reservoir plates because the bottoms of the wells are closed, which means that any substance must be both received and extracted from the well through the upper orifice or opening. In certain embodiments, the first perimeter of the receiving opening located in the upper portion is substantially larger than the second perimeter of the discharge opening located in the lower portion. As one of skill in the art would recognize, the second perimeter of the discharge opening must be small enough to allow the surface tension of the contents of the well to be retained within the carrier plate and not pass through the discharge opening. The actual perimeters of either opening may vary, according to the contents of the well and/or the amount of pressure desired to force the contents to pass through the discharge opening.

Such assays may include screening of pharmaceuticals, general laboratory procedures, chemical or biological binding assays, filtration assays, chemical synthesis, agrochemical screening, food testing, environmental testing, biochemical techniques, histochemical techniques, microbiological techniques, medical testing, plant techniques, protein and/or nucleic acid techniques and/or cosmetic testing. The present multi-well reservoir plate may also be useful for handling reagents and/or samples that require transfer from one multi-well reservoir plate to another plate or to a membrane, such as for crystallization experiments. Advantageously, this transfer may be accomplished without the aforementioned pipetting step that is required to transfer substances from one conventional reservoir plate to another.

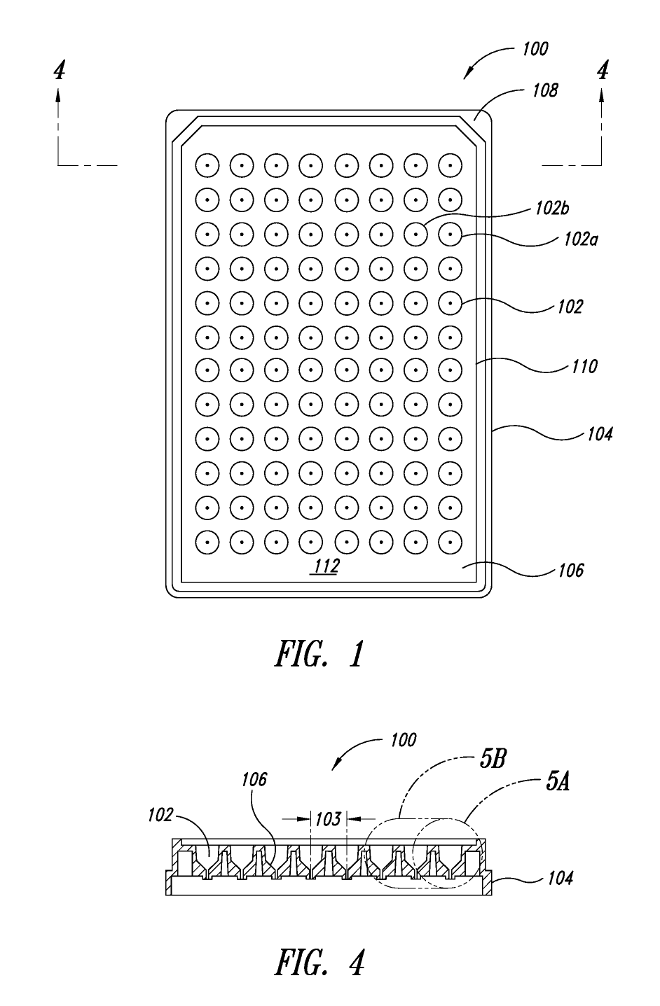

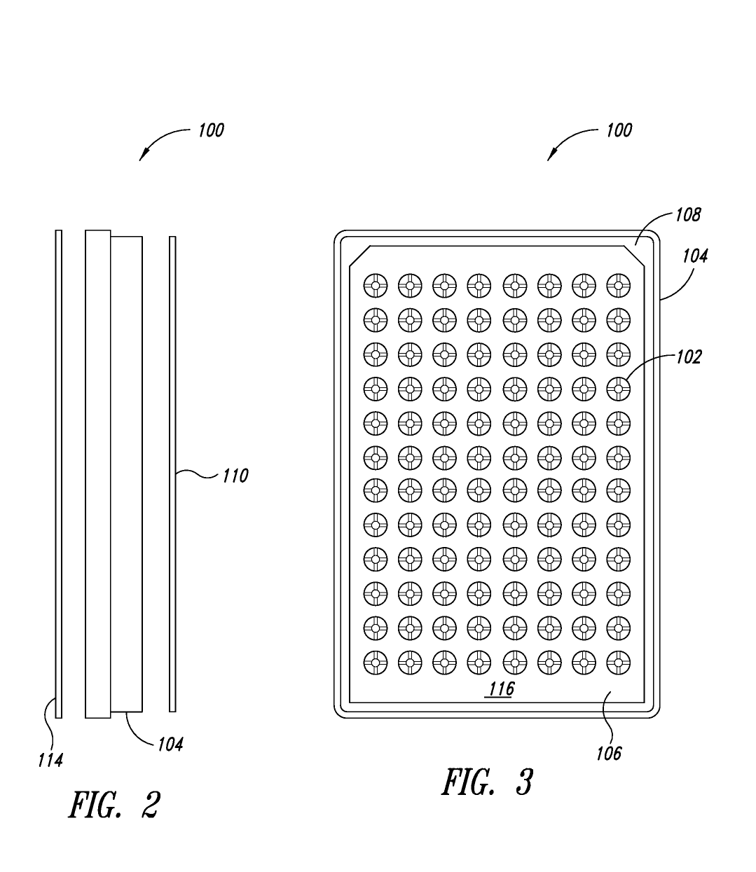

FIGS. 1-5 show the multi-well reservoir plate 100 having a number of wells 102. Depending on a particular goal or application, the number of wells 102 formed in the plate 100 may vary from two wells to many wells. Reservoir plates are generally configured to have a predetermined number of wells for different applications where some of the more common configurations include plates having 2, 4, 6, 12, 24, 48, 96, 384, 864, 1536, 3456, and 9600 wells. It is understood and appreciated, however, that the multi-well reservoir plate 100 may have any intermediate number of wells 102 or a number of wells that exceeds 9600. In the illustrated embodiment, the multi-well reservoir plate 100 includes 96 wells 102. In at least one embodiment, the wells may be placed in any configuration in order to attain a desired well center-to-well center distance. In one embodiment, a center-to-center distance 103 (FIG. 4) is in the range of about 0.5 millimeters (mm) to about 200.0 mm.

One benefit to having a greater number of wells 102 in the plate 100 is to minimize the number of plates 100 needed to carry out high throughput screening of biological or pharmaceutical samples where extremely small volumes of many samples are to be screened. Additionally or alternatively, smaller sized wells 102 reduce a corresponding volume of the reagents and/or samples per reaction.

The multi-well reservoir plate 100 includes a frame portion 104 coupled a plate portion 106, where the wells 102 are formed in the plate portion 106. In one embodiment, a portion 108 of the multi-well reservoir plate 100 is indexed, marked, truncated, or otherwise labeled to allow the multi-well reservoir plate 100 to be oriented in a selected direction for assembly, automation and/or other purposes.

In addition to the number of wells 102, the multi-well reservoir plate 100 may have dimensions such as length, width, and thickness. The dimensions may be selected so that the plate 100 may be used in standard processing equipment, such as a thermocycler or may be customized for particular applications. In one embodiment, the plate 100 has the dimensions of approximately 127 (length)×85 (width)×14 (thickness) mm, which are approximately the dimensions of a conventional reservoir plate that is used in an automated process (i.e., robotically or mechanically handled and/or transferred). It is appreciated that the number of wells 102 formed in the plate is not dependent or necessarily correlated to the dimensions of the plate 100.

The multi-well reservoir plate 100 may be utilized with instrumentation or other automatic means of conducting multiple experiments. In one embodiment, the multi-well reservoir plate 100 is configured to be in compliance with one industry format, which is determined by the Microplate Standards Development Committee of the Society of Biomolecular Screening and the American National Standards Institute for automated laboratory instrumentation. See ANSI/SBS 1-2004 (footprint dimensions); ANSI/SBS 2-2004 (height dimensions); ANSI/SBS 3-2004 (bottom outside flange dimensions); ANSI/SBS 4-2004 (well positions). See also Astle, J. Biol. Screen. Vol. 1, No. 4, pp. 163-169 (1996). Configuring the multi-well reservoir plate 100 according to one particular industry format may advantageously allow the plate 100 to be used with popular and/or standardized automation equipment.

In other embodiments, the multi-well reservoir plate may not have a “standard footprint,” but instead may be of any shape or size. Specifically, the multi-well reservoir plate may be square, rectangular, circular, triangular, elliptical, or any other configuration.

In certain aspects, the multi-well reservoir plate 100 is made from glass, quartz, metal, plastic, such as polystyrene or polypropylene, polyolefins, such as cyclo-olefin polymer or cyclo-olefin copolymer. One type of reservoir plate made from at least one of the above-identified materials is described in U.S. Pat. No. 6,232,114.

In certain aspects, it may be desirable for the multi-well reservoir plate 100 to be resistant to degradation or deterioration from dimethylsulfoxide (DMSO), formamide, formaldehyde, alcohols, acids, bases, or other chemicals. In one embodiment, the multi-well reservoir plate 100 is sterile and/or may be sterilized before each use. In another embodiment the multi-well reservoir plate 100 is RNAse and/or DNAase and/or protease free.

In one embodiment, the multi-well reservoir plate 100 is made from a material that is opaque and/or has a low luminescence or fluorescence. By way of example, the plate 100 may be made from a material that exhibits an autofluorescence at screening wavelengths at or below about 5% of the signal observed from the assay. Exemplary screening wavelengths employed that are typically used for screening purposes are 337 nanometers (nm), 360 nm, 400 nm, 405 nm, 430 nm, 460 nm, 480 nm, 485 nm, 520 nm, 535 nm, and 590 nm, however other values may also be used. Additionally or alternatively, the multi-well reservoir plate 100 is made from a material that may reduce or even substantially block the transmission of light. In another embodiment, the material of the multi-well reservoir plate 100 provides a background that may augment and/or be beneficial with optical detection and/or activation methods.

In one embodiment, the multi-well reservoir plate 100 includes a covering that is pigmented. One type of pigment that may be used for the covering is carbon black.

The wells 102 or other portions of the multi-well reservoir plate 100 may be coated with at least one chemical, biological reagent, and/or factor. Coatings may be applied by any suitable method, including printing, spraying, radiant energy, ionization, dipping, stamping, pressing, adhering, derivatizing a polymer, etching, chemical reaction, any combination thereof or other contact. For example, derivatized polymers may be reacted with a selected chemical moiety such that a covalent or non-covalent attachment occurs. Chemical moieties may vary depending on the application, but may include binding partners, solid synthesis components for amino acid or nucleic acid synthesis, or cell culture components.

Alternatively, the wells 102 of the plate 100 may be coated with chemicals or other materials for a variety of purposes. For example, some purpose of the coatings may be to increase or decrease surface tension, to decrease or prevent oxidation, and/or to decrease or prevent plate degradation. In one embodiment, the wells 102 are coated with silicone or Teflon® (polytetrafluoroethylene), to render the surface more hydrophobic. In another embodiment, the wells 102 are coated with an epitope tag, such as glutathione or coated with an extracellular matrix component, such as fibronectin, collagen, laminin, or other similar or equivalent substance. In yet another embodiment, the wells 102 are coated with at least one poly-L or poly-D amino acid, biotinylated molecules, such as streptavidin, a resin, a polymer, a silica gel, a matrix or other chemical. The resin, polymer, silica gel, matrix or other chemical may operate as a separation gradient for the substance in the wells 102. Alternatively, the resin, polymer, silica gel, matrix or other chemical may operate as a carrier of another biological or chemical agent, such as bifunctional heterocycle, heterocyclic building block, amine, alcohol, carboxylic acid, sulfonyl chloride, or other agent. In yet another embodiment, the wells 102 are coated with at least one radioisotope, including but not limited to ³²P, ³⁵S and/or ³H-nucleic acid (such as thymidine, guanine, adenine, uracil or cytosine).

During processing of the substance or substances in the wells 102 of the multi-well reservoir plate 100, the plate 100 may be heated and/or cooled to effect a desired change or to determine a resistance of the substance to such a change.

In certain situations it may be desirable to prevent evaporation of the substance in the wells 102 of the multi-well reservoir plate 100 by placing a cover 110 over the wells 102 after adding the substance (e.g., a sample and/or a reagent) to at least one of the wells 102 of the multi-well reservoir plate 100. Small volumes of the substance may evaporate relatively quickly and in some cases the substance in the outermost wells 102a, which are located adjacent to the frame 104, evaporates at a faster rate than the interior wells 102b closer to the center of the plate 106. The faster evaporation rate for the substance in the outermost wells 102a may be caused when the cover 110 contracts, for example thermally contracts, exposes the substance to the environment, and thus reduces the vapor pressure in the outermost wells 102a.

The multi-well reservoir plate 100 may have an upper covering 110 for covering an upper surface 112 and/or a lower covering 114 for covering a lower surface 116. In the illustrated embodiment, the upper covering 110 is a thin transparent sheet and is shaped to fit within the frame 104 while substantially covering both the interior wells 102b and the outermost wells 102a. The respective coverings 110, 114 may be a film, such as an adhesive film; a porous or non-porous, permeable, semi-permeable or impermeable membrane; a lid, a chemical layer (such as wax or oil), or some other type of covering. One of skill in the art would recognize that any respective coverings 110, 114 may be heat sealable and/or may be peelable, rupturable, burstable or otherwise removable or able to allow the user to access the content(s) of the well(s). One purpose of such a covering is to reduce or prevent evaporation of the substance in the well. Another purpose is to control condensation within the well during a heating or a cooling of the substance in the well.

A variety of adhesive films or seals may be used with the multi-well reservoir plate 100. In one embodiment, a single-layer, multi-layer or rolled adhesive film is applied to all or part of a upper surface 112 and/or a lower surface 116 of the multi-well reservoir plate 100. Adhesive films may be selected for particular qualities, such as seals that exhibit solvent or chemical resistance, ultra-violet radiation resistance, provide a moisture and/or oxygen barrier, are resealable, are gas permeable, are clear or colored, have either a high or a low temperature conductivity, have low protein binding, are temper evident, are heat sealable or some combination thereof.

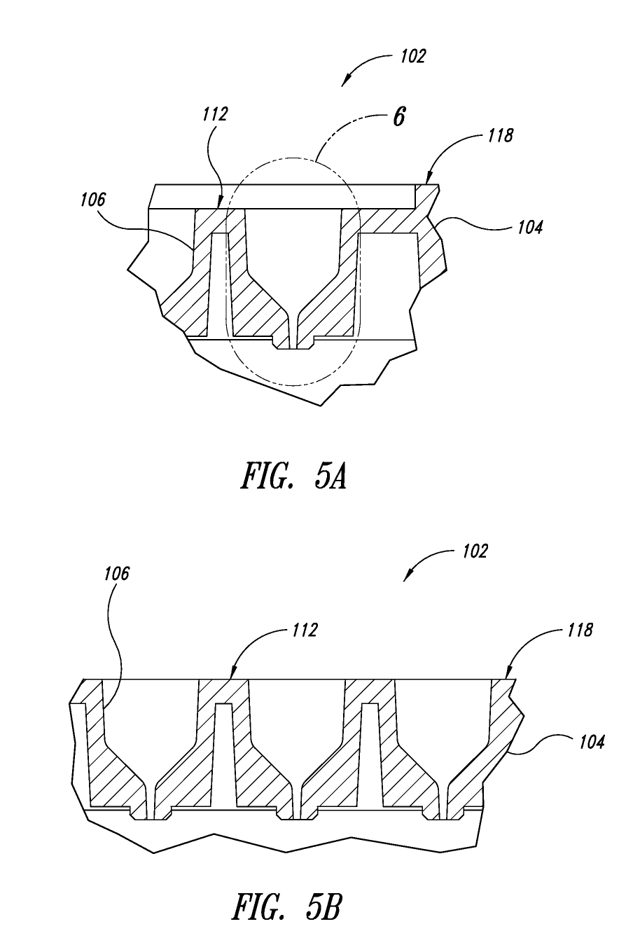

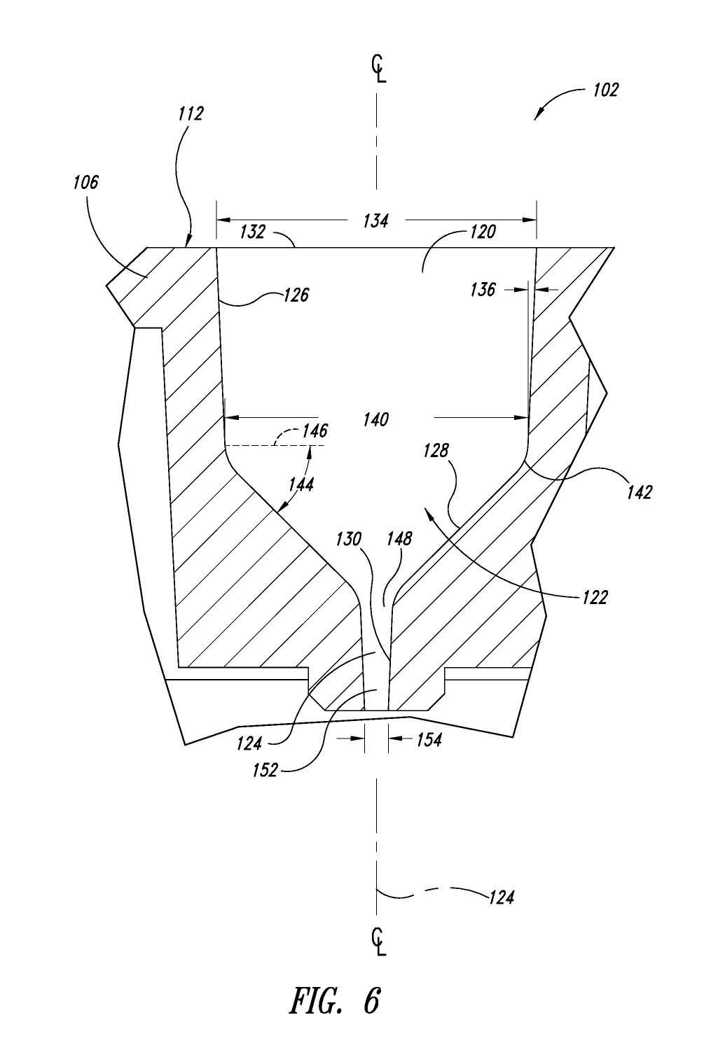

FIG. 5A shows that the upper plate surface 112 is recessed or lowered relative to an upper frame surface 118 of the frame 104, which forms a perimeter around the plate 106. FIG. 5B shows a slightly alternate embodiment where the upper plate surface 112 is flush or approximately flush with the upper frame surface 118 of the frame 104. The wells 102 of the multi-well reservoir plate 100 may be any cross sectional shape such as square, circular, hexagonal, elliptical, rectangular, or some other shape.

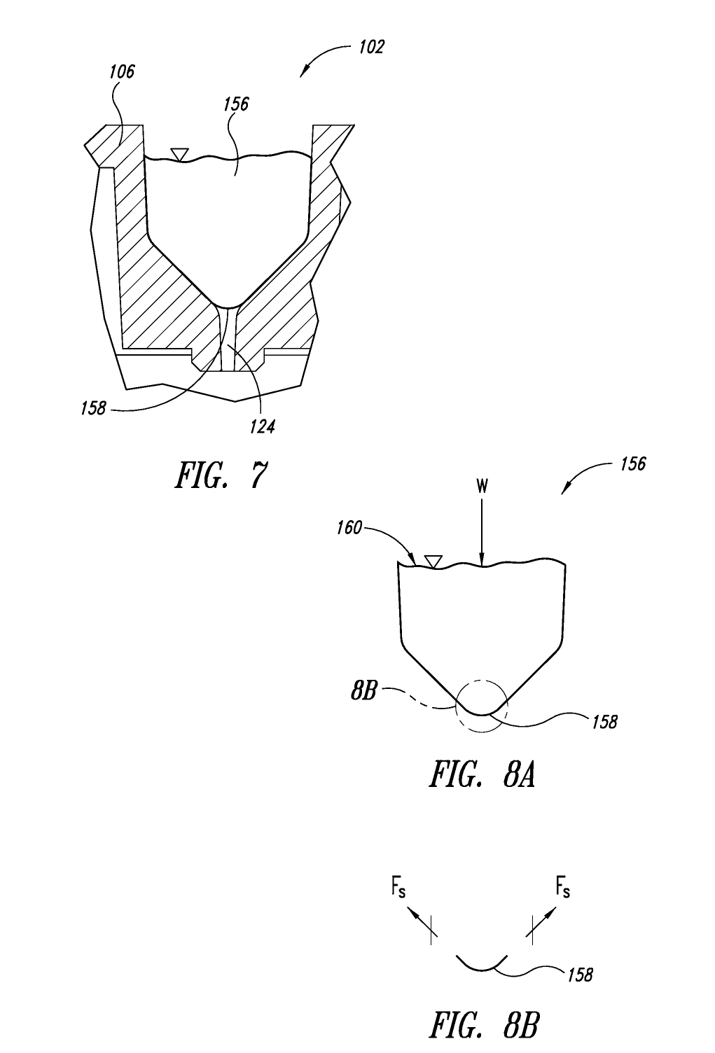

FIG. 6 shows the well 102, which comprises a receptacle for a substance formed in the plate 100, according to one illustrated embodiment. The well 102 includes an upper portion 120, a tapered portion 122, and a lower portion 124. The upper portion 120 includes a first wall 126 surrounding and thus forming a first volume. The tapered portion 122 includes a tapered wall 128 surrounding and thus forming a second volume. The lower portion 124 includes a lower wall 130 surrounding and thus forming a passage through which the substance in the well 102 may be discharged. The tapered portion 122 is located between the upper portion 120 and the lower portion 124. In one embodiment the tapered portion 122 comprises a conical, necked down portion or a conical, funneling portion for the well 102. The upper portion 120 includes a receiving opening 132 with a receiving perimeter 134.

The first wall 126 of the upper portion 120 may be angled or sloped with a first angle 136 as the first wall 126 extends toward the tapered portion 122 and subsequently joins with the tapered wall 128. The first angle 134 may be in a range of about −30 to 45 degrees when the first angle 136 is measured from a centerline axis 138 extending vertically through the well 102.

The tapered wall 128 of the tapered portion 122 includes a first opening 140 that is located at an intersection 142 of the first wall 126 and the tapered wall 128. The tapered wall 128 may be angled or sloped with a tapered angle 144 as the tapered wall 128 extends toward the lower portion 124 and subsequently joins with the lower wall 130. The tapered angle 144 may be in a range of about 10 to 60 degrees when the tapered angle 144 is measured relative to a first plane as indicated by line 146, where line 146 is substantially parallel with the upper plate surface 112 and may also be substantially perpendicular with the centerline axis 138.

The lower portion 122 includes an entrance opening 148 having an entrance perimeter 150 and a discharge opening 152 having a discharge perimeter 154. The passage that extends from the upper opening 148 to the discharge opening 152 is in fluid communication with the upper portion 120. In one embodiment, the discharge perimeter 154 is smaller than the entrance perimeter 150 because the lower wall 130 tapers radially inward by at least some amount from the entrance opening 148 toward the discharge opening 152.

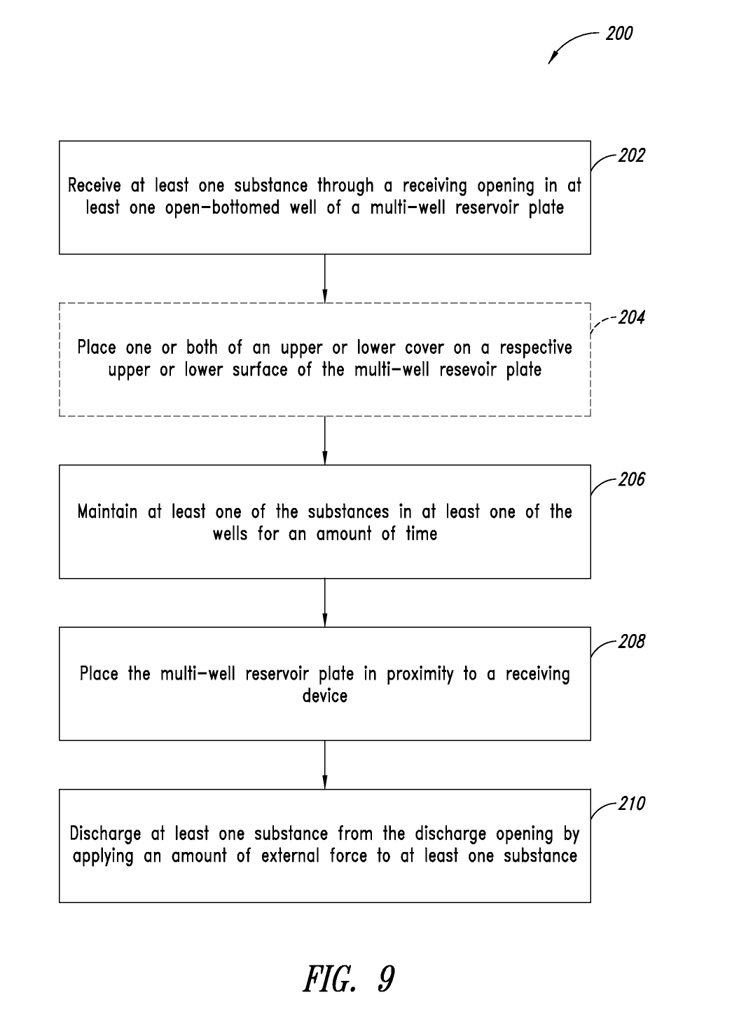

FIGS. 7, 8A, and 8B show that the receiving opening 132 of the upper portion 120 includes the receiving perimeter 134 and the entrance opening 148 of the lower portion 124 includes the entrance perimeter 150, where the entrance perimeter 150 is sufficiently smaller than the receiving perimeter 134. In one embodiment, the size of the entrance perimeter 150 is small enough to permit the substance 156 located in the upper portion 120 and in the tapered portion 122 to remain in those respective portions 120, 122. The substance 156 is primarily supported by the tapered wall 128, while a portion 158 of the substance 156 spans or bridges the entrance perimeter 150. Referring to FIGS. 8A and 8B, it is understood that the size of the entrance perimeter 150 permits surface tension “Fₛ” reaction forces associated with the portion 158 of the substance 156 that react the weight “W” of the substance 156, maintain the substance in equilibrium, and prevent the substance from being pushed into the passage of the lower portion 124. The surface tension Fₛ reaction forces operate to maintain the substance 156 within the upper and/or tapered portions 120, 122, respectively and not allow the substance 156 to leak or otherwise substantially enter into the passage of the lower portion 124. In one embodiment, the volume of the substance that can be placed and supported in the combination of the upper and tapered portions 120, 122 is in a range of about 1.0 microliter (μL) to about 100.0 milliliters (mL).

### Methods of Use

FIG. 9 is a flowchart showing a method 200 of using a multi-well reservoir plate. One purpose of the multi-well reservoir plate is to temporarily store a substance or substances in the open-bottomed wells of the plate and then transfer the substances to a receiving device, such as a multi-well reservoir plate having closed-bottom wells, for example. The open-bottomed wells of the multi-well reservoir plate may advantageously permit the transfer to take place rapidly, much faster than the conventional method of manually transferring the substances, one well at a time, using a hand-held liquid handling or transferring device, such as a pipette. In addition, the multi-well reservoir plate may be a less expensive alternative to using expensive, automated pipette machines.

Additionally or alternatively, the multi-well reservoir plate and method of using the same may advantageously reduce and/or eliminate handling errors, repeatedly attain accurate volumetric measurements during transfer, and reduce and/or eliminate an amount of cross contamination among the wells that may occur when the substances are transferred using conventional pipetting processes.

The method 200 commences by receiving at least one substance through a receiving opening located in at least one well of an open-bottomed multi-well reservoir plate, at 202. Optionally, a cover, which may be an upper and/or lower cover, may be placed on a respective upper and/or lower surface of the plate, at 204. The at least one substance is maintained, supported, and/or retained in the at least one well for a desired amount of time, at 206. At least a portion of the at least one substance spans an opening formed in the well, where the opening is in fluid communication with a discharge opening. In one embodiment, the surface tension of the substance maintains the at least one substance in the well without permitting the weight of the substance to urge the substance toward the discharge opening.

The multi-well reservoir plate may then be place above or near a receiving device, at 208. Then, the at least one substance may be discharged from the at least one open-bottomed well by applying an amount of external force to the at least one substance, at 210. The external force may be a first pressure applied to an upper surface of the substance, which forces the substance toward the discharge opening. The external force may be a second pressure applied to a lower surface of the substance, which operates as a vacuum pressure to pull the substance toward and out of the discharge opening. Alternatively, the external force may be a centrifugal force corresponding to a radial acceleration of a centrifuge device or simple a translational force corresponding to a translational acceleration of the plate to urge the substance toward the discharge opening. Additionally or alternatively, the external force may be any combination of the above-described external forces, may be some other mechanically, electrically, or thermally applied external force that operates to urge the substance toward and eventually out of the discharge opening of the open-bottomed well of the plate.

In addition to the aforementioned method of using and designated purpose of using the multi-well reservoir plate, the plate may be used for other purposes. For example, the multi-well reservoir plate may be used for transferring reagents for protein crystallization techniques. In particular, several individual solvents may be added to the wells of the multi-well reservoir plate and subsequently transferred to a crystallography plate.

Additionally or alternatively, the present multi-well reservoir plate may be used for receptor binding assays. Specifically, a labeled ligand may be incubated with a target receptor in the presence of a compound that is being tested for interfering with receptor-ligand binding. Subsequently, the receptor and ligand with the compound are separated by filtration or washing, and the amount of labeled ligand bound to the receptor may be quantified.

In another example, the present multi-well reservoir plate may be used for testing pharmaceuticals for therapeutic activity and/or toxicology. In particular, a test chemical may be contacted with a biological or chemical target in a multi-well plate such that if the sample modulates a biological or chemical reaction, a change in fluorescence with the reporter will be measurable.

In yet another example, the multi-well reservoir plate may be used with a filter or membrane corresponding the surface area of at least one orifice of at least one well for eluting or precipitating samples of protein, DNA (including plasmids, cosmids, phage), RNA, any combination thereof or other biological or chemical samples.

In still yet another example, the multi-well reservoir plate may be used for cell and/or tissue culture techniques. Such cell or tissue culture may include plant cells, animal cells (including mammalian cells, e.g. human cells), prokaryotic cells, yeast cells, fungal cells, other types of eukaryotic cells, or tissues from plants, animals, fungus, any combination thereof or other sources.

In still yet another example, the multi-well reservoir plate may be used to select particular mutants by exposing them to selected chemicals, such as amino acids, and subsequently filtering or washing away the unselected mutants.

In another example, the multi-well reservoir plate may be used for processing biological samples or specimens from a clinical or forensic setting (such as blood, bodily fluids or tissues, urine, lymph, saliva, hair, semen, vaginal secretions, nasal secretions, ocular secretions, gastric secretions, intestinal secretions, mucous, bronchial secretions, any combination thereof or other biological tissues or remnants). In a clinical or forensic circumstance, reagents may be added to the wells of the multi-well reservoir plate and stored until needed to examine biological specimens.

In yet another example, some or all of the necessary reagents for preserving biological specimens from a clinical or forensic setting may be added to the wells (such as a DMSO mixture, buffy coat or glucose mixture) and subsequently transferred to the biological sample when necessary.

In still yet another example, the multi-well reservoir plate may be used for reverse transcriptase (RT) reactions in which many or all of the reagents or sample may be added to the wells of the multi-well reservoir plate until needed to transfer to the remaining reagents and/or RNA sample.

In another example, the multi-well reservoir plate may be used for polymerase chain reactions (PCR) in which many or all of the reagents and/or sample may be added to the wells of the multi-well reservoir plate until needed to transfer to the remaining reagents and/or DNA sample.

In yet another example, the multi-well reservoir plate may be used for in vitro or in situ hybridizations or diagnostics. In particular, some or all of the necessary reagents may be added to at least one well of the multi-well reservoir plate until needed to transfer to the biological sample (such as a cell, tissue, organ or whole embryo, larval or adult body).

In still yet another example, the multi-well reservoir plate may be used for cytotoxicity assays, such as NK cell or LAK cell assays. Specifically, target cells may be radiolabeled and incubated with cytotoxic cells (with or without additional cytokines or other factors). Following a washing step or filtration step, the media is measured for radioactivity that was released from the cytotoxicity exhibited against the target cells.

In a final example, the multi-well reservoir plate may be used for examining biological or chemical samples, such as by NMR, IR, or mass spectrometry.

### Manufacturing the Multi-Well Reservoir Plate

The multi-well reservoir plate may be fabricated from at least one liquefied material, such as polystyrene, which is then cooled in a mold to form the multi-well reservoir plate. Alternatively, the multi-well reservoir plate may be made by pressing and/or stamping a sheet material, such as a metallic sheet material, to at least form the wells in the plate, such as a metallic sheet.

The various embodiments described above can be combined to provide further embodiments. All of the above U.S. patents, patent applications and publications referred to in this specification are incorporated herein by reference. Aspects can be modified, if necessary, to employ devices, features, and concepts of the various patents, applications, and publications to provide yet further embodiments.

These and other changes can be made in light of the above-detailed description. In general, in the following claims, the terms used should not be construed to limit the invention to the specific embodiments disclosed in the specification and the claims, but should be construed to include all types of microtiter, micro, and/or multi-welled plates and methods of manufacturing and/or using the same that operate in accordance with the claims. Accordingly, the invention is not limited by the disclosure, but instead its scope is to be determined entirely by the following claims.

1. A carrier comprising:
a frame; and
a plate coupled to the frame, the plate having a plurality of receptacles formed in the plate, at least one receptacle having an upper portion having a first wall forming a first volume, a tapered portion having a tapered wall forming a second volume, and a lower portion having a lower wall forming a passage, the tapered portion is disposed between the upper portion and the lower portion, the upper portion includes a receiving opening with a first perimeter, the lower portion includes a discharge opening at one end of the passage, wherein the passage is in fluid communication with the first volume of the upper portion, the discharge opening includes a with a second perimeter that is smaller than the receiving opening of the upper portion by an extent that a substance that is received in one or both of the first and second volumes remains therein until acted upon by an amount of applied force.

2. The carrier of claim 1 wherein the tapered portion comprises a necked down portion.

3. The carrier of claim 1 wherein the first wall of the upper portion extends radially inward from the first perimeter toward the tapered portion by an angle in a range of about 0-15 degrees.

4. The carrier of claim 1 wherein the tapered wall is coupled to the first wall and extends radially inward from the first wall of the upper portion toward the lower wall of the lower portion by an angle in a range of about 10-85 degrees.

5. The carrier of claim 1 wherein the lower wall of the lower portion extends radially inward from the tapered wall of the tapered portion toward the discharge opening by an angle in a range of about 0-15 degrees.

6. The carrier of claim 1 wherein the plate is made from a material selected from a group consisting of: a glass, a metal, a plastic, and a polyolefin.

7. The carrier of claim 1 wherein the first perimeter of the receiving opening located in the upper portion is substantially larger than the second perimeter of the discharge opening located in the lower portion.

8. The carrier of claim 1 wherein the number of the plurality of receptacles formed in the plate is in a range of about 2 to 20,000.

9. The carrier of claim 1, further comprising:
a coating applied to a surface area of at least the first wall of the upper portion and the tapered wall of the tapered portion.

10. The carrier of claim 9 wherein the coating is substantially non-reactive with a biological substance received in the receptacles.

11. The carrier of claim 9 wherein the coating comprises Teflon®.

12. The carrier of claim 1 wherein the applied force is an inertial force caused by an acceleration of the carrier.

13. The carrier of claim 1 wherein the applied force is an amount of pressure acting on an upper surface of the substance in at least one of the receptacles.

14. The carrier of claim 1 wherein the applied force is an amount of pressure applied through the passage of the lower portion and acting on a lower surface of the substance in at least one of the receptacles.

15. The carrier of claim 1, further comprising:
a cover positioned below the plate and in contact with the lower portions of the receptacles.

16. The carrier of claim 15 wherein the cover is made from a material selected from the group consisting of: a film, a membrane, a lid and a chemical layer.

17. The carrier of claim 15 wherein the plate is pigmented.

18. A method of using a multi-well reservoir plate, the method comprising:
adding at least one substance to at least one well of the reservoir plate;
supporting the at least one substance in an upper volume portion of the at least one well for a desired amount of time, wherein a first portion of the at least one substance is supported by a tapered wall of the at least one well and another portion of the at least one substance spans an opening of a passage formed in and extending through a lower portion of the well, the at least one passage in fluid communication with the upper volume portion of the at least one well; and
discharging at least some of the at least one substance from the upper volume portion of the well through and out of the passage in the lower portion of the well by applying an amount of force to the at least one substance.

19. The method of claim 18 wherein adding the at least one substance to the at least one well of the reservoir plate includes pipetting the at least one substance into a receiving opening of the well.

20. The method of claim 18 wherein applying the amount of force to the at least one substance includes applying a pressure.

21. The method of claim 18 wherein applying the amount of force to the at least one substance includes applying an inertial force.

22. The method of claim 18 wherein supporting the at least one substance in an upper volume portion of the at least one well for an amount of time includes covering the at least one well with a cover.

23. The method of claim 18, further comprising:
removing the covering before applying the amount of force to the at least one substance.
